(19) United States
(12) Patent Application Publication
(10) Pub. No.: US 2010/0252371 A1
(43) Pub. Date: Oct. 7, 2010

(54) BRAKING ARRANGEMENTS AND METHODS

(76) Inventor: Andrew Gray, York (GB)

Correspondence Address: KLARQUIST SPARKMAN, LLP, 121 SW SALMON STREET, SUITE 1600, PORTLAND, OR, 97204, US

(21) Appl. No.: 12/742,242

(22) PCT Filed: Nov. 11, 2008
(86) PCT No.: PCT/GB2008/051052

§ 371 Date: May 10, 2010

(30) Foreign Application Priority Data
Nov. 12, 2007 (GB) 0722156.7

(51) Int. Cl. B62B 5/04; B60B 33/00

(52) U.S. Cl. 188/1.12; 188/5; 188/74

(57) ABSTRACT

A braking arrangement for a wheel of a shopping cart or the like includes a braking arm moveable about an axis from a free running position to a braking position when the wheel is lifted from the ground. The braking arrangement includes a damping assembly which initially resists movement of the braking arm towards the braking position.

The present invention relates to braking arrangements and braking methods for wheels, castors and the like and in particular, but not exclusively, to braking arrangements and braking methods for wheels or castors of conveyances which are pushed by a human, such as shopping carts or trolleys.

Removal of shopping carts from the desired area around a retail outlet is a major problem for retailers and several prior art systems have been designed to alleviate this problem. These systems rely on some sort of braking action either to the wheel of the shopping cart or by interposing a braking element between the shopping cart and the ground. One known system uses a radio frequency (RF signal) or a magnetic field located, for example, at the perimeter of the permitted area for the shopping carts, to trigger the action of a braking system. With the brake in place the shopping cart is, of course, very difficult to move. However, it is possible in some cases to overcome such RF-based or magnetic systems by lifting the shopping cart out of range of the RF or magnetic trigger. For example, the shopping cart may be lifted for a short distance at the perimeter of the retail premises.

The present invention seeks, at least partially, to mitigate or alleviate the above-mentioned problems. Embodiments of the present invention seek to provide a new form of braking arrangement and a new method of applying a brake which at least partially alleviates the above disadvantages. The braking arrangement and braking method according to the invention can, of course, be used independently of prior art braking systems.

According to a first aspect of the present invention there is provided apparatus for preventing rotation of at least one wheel member, comprising:
at least one braking member rotatable about an axis of a wheel member between a non-braking position and a braking position;
at least one biasing element arranged to bias the braking member to rotate into the braking position; and
a damping assembly arranged to selectively resist a bias provided by the biasing element.

Typically, the wheel member is a wheel or a castor.

In one preferred embodiment the damping assembly further comprises:
a hydraulic unit comprising a piston element, cylinder element in which the piston element at least partially extends and damping fluid arranged to selectively resist motion of the piston element in the cylinder element; and
a rocker arm having a first end arranged to press against an external end of the piston element and a further end arranged to press against a contact surface of the braking member.

Preferably the first end of the rocker arm comprises a concave running surface on which the external end of the piston element is urged.

In preferred configurations the damping assembly selectively resists the biasing effect for a predetermined period of time subsequent to the wheel member being removed from a running surface.

In further preferred embodiments the braking member further comprises:
an elongate brake arm member arranged to pivot about the axis of the wheel member at a first end region and including a cam surface providing the contact surface on which the external end of a rocker arm rides.

Preferably the apparatus further comprises:
a jockey wheel rotatable about a minor axle at a distal end region of the brake arm.

In further preferred embodiments the apparatus comprises:
a locking plate; and
at least one locking plate biasing member arranged to urge a free end of the locking plate away from a base plate member; wherein
the brake arm member urges the locking plate against the base plate member as the brake arm member moves from a non-braking position to the braking position.

Preferably the free end of the locking plate is arranged to spring away from the base plate member when the brake arm member is located in the braking position to thereby prevent counter rotation of the brake arm member so that the brake arm member is locked in the braking position.

In still further preferred embodiments the apparatus further comprises a release assembly, the release assembly comprising:
a rotatable body portion comprising a keyhole region and cam portion, the keyhole region being arranged to receive a reset key, the body portion being rotatable with turning of the reset key to thereby engage the cam portion with the locking plate to urge the locking plate against the base plate member.

Preferably the apparatus further comprises a recess in the base plate member to receive the locking plate.

Preferably the apparatus further comprises:
a locking arm extending from the brake arm member to engage with an adjacent braking system and selectively prevent the braking member being located in the braking position when the adjacent braking system is deployed.

In further preferred embodiments:
the base plate member comprises at least one base recess comprising a central pin element and at least one angled side wall region; and wherein the apparatus further comprises
a locking nut element, for each base recess, having a first side comprising a nut recess and angled side wall locatable in the base recess, and a further side comprises a contact surface offset from a central axis of the nut element.

Preferably the base plate member comprises two recesses.

According to a second aspect of the invention there is provided a castor for a shopping cart, comprising:
a wheel member;
a horn member comprising forks between which the wheel member is arranged to rotate about the wheel axis; and
the apparatus as defined in the first aspect of the invention.

In a preferred embodiment of this aspect of the invention the castor further comprises:
a braking assembly arranged to retard motion of the wheel member responsive to a wireless trigger.

According to a third aspect of the invention there is provided a shopping cart comprising the castor as defined in the second aspect of the invention.

According to a fourth aspect of the invention there is provided a method of preventing rotation of at least one wheel member of a castor, comprising the steps of:
during a non-braking mode of operation in which a wheel member of the castor runs in contact with a running surface, maintaining at least one braking member in a non-braking position;
during a braking mode of operation in which the wheel member of the castor is removed from contact with the running surface, urging the braking member into a braking position in which the braking member is located between the wheel member and the running surface; and
immediately subsequent to the removal of the wheel member from contact with the running surface, via a damping assembly, selectively resisting a biasing effect of at least one biasing member arranged to bias the braking member into the braking position.

Preferably the method further comprises the steps of:
resisting biasing of the braking member into the braking position for a predetermined period of time immediately subsequent to removal of the wheel member of the castor from the running surface.

In preferred embodiments the method further comprises the steps of:
subsequent to biasing of the braking member into the braking position, locking the braking member in the braking position via a locking plate.

In further preferred embodiments the method further comprises the steps of:
subsequent to locking the braking member in the braking position, releasing the braking member by turning a key in a keyhole of a release assembly thereby turning a cam portion of a rotatable body, rotation of the cam portion urging the locking plate into a recess on a base plate member to thereby release the braking member.

Preferably the method further comprises securing a base plate to a fork of the castor by the steps of:
selectively locating a first nut element in a base recess and holding the fork between an abutment surface and a contact surface of the nut.

Preferably the abutment surface comprises a contact surface of a further nut element.

Preferably the method further comprises the steps of:
prior to holding the base plate, selectively orientating at least one nut element in one of a plurality of possible orientations in a respective recess of the base plate.

Preferably the method further comprises the steps of:
preventing movement of the braking member into the braking position if a braking assembly of the castor is deployed.

One problem in constructing braking arrangements which operate when a shopping cart or the like is lifted away from its running surface (that is, the ground) is that it may be undesirable for the braking arrangement to operate immediately. Short term lifting of the shopping cart by an authorised user may be necessary, for example, when the shopping cart passes over a kerb, and the braking arrangement should not operate in this period. Typically, the desired delay is of the order of five seconds and more especially of the order of about two seconds.

For a better understanding of the invention and to show how the same may be carried into effect, reference will be made by way of example only, to the following drawings in which:

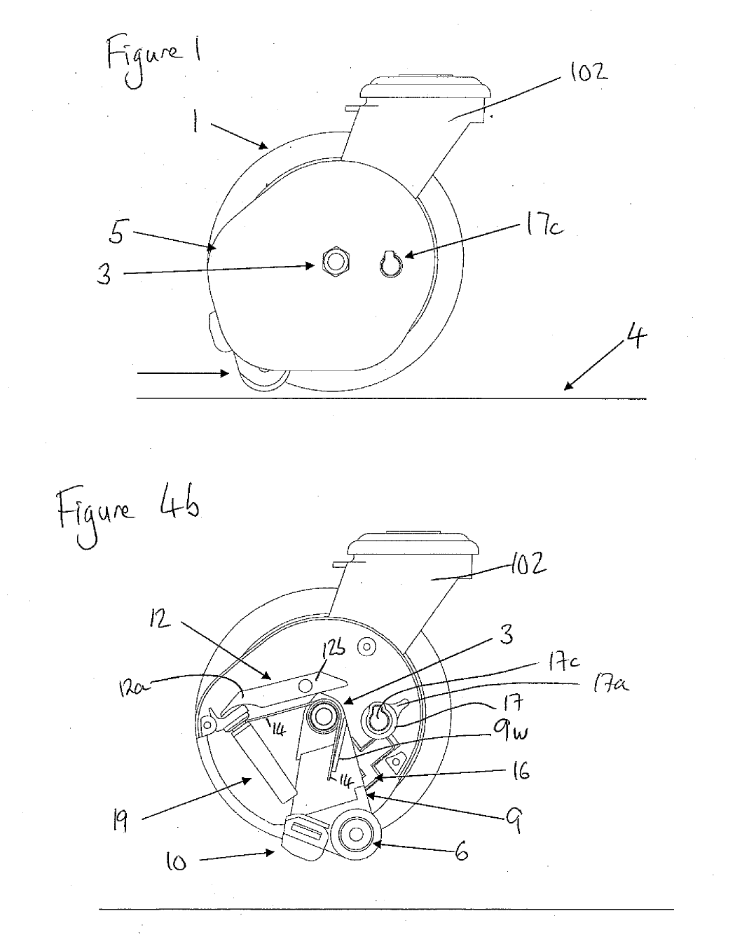

FIG. 1 is a side view of a castor of a shopping cart incorporating the braking arrangement of the invention;

FIG. 2 is a view of a castor similar to FIG. 1 with a cover removed and with the braking arrangement in a free running position;

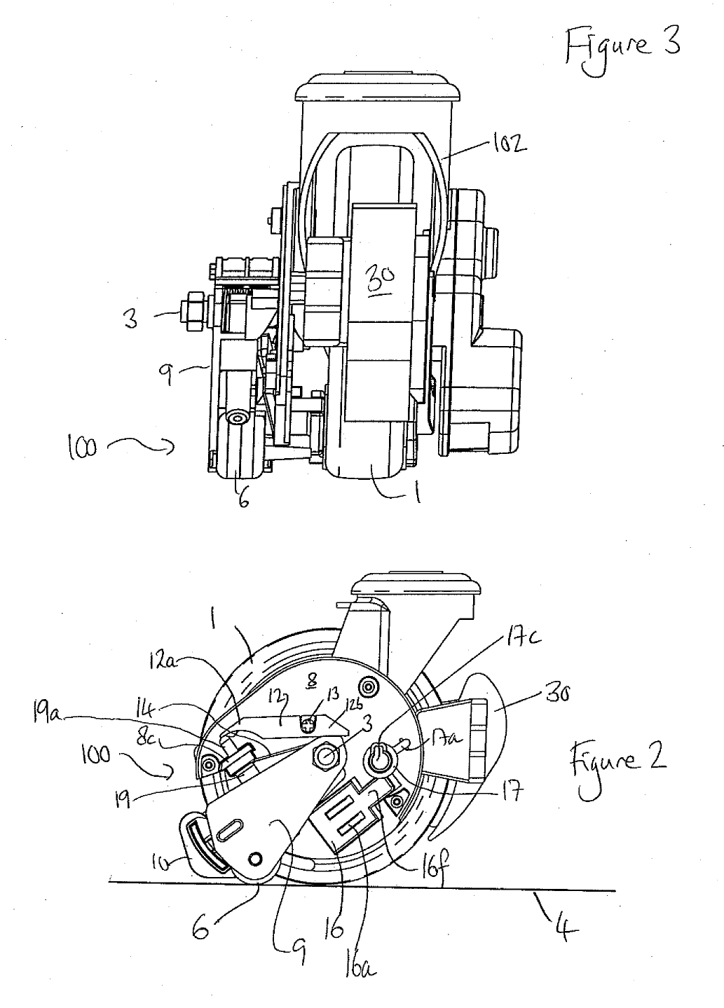

FIG. 3 is an end view of the castor of FIG. 2;

FIG. 4a is similar FIG. 2 showing the braking arrangement displaced towards a braking position;

FIG. 4b is similar to FIG. 4a with a portion of the brake arm 9 removed for clarity;

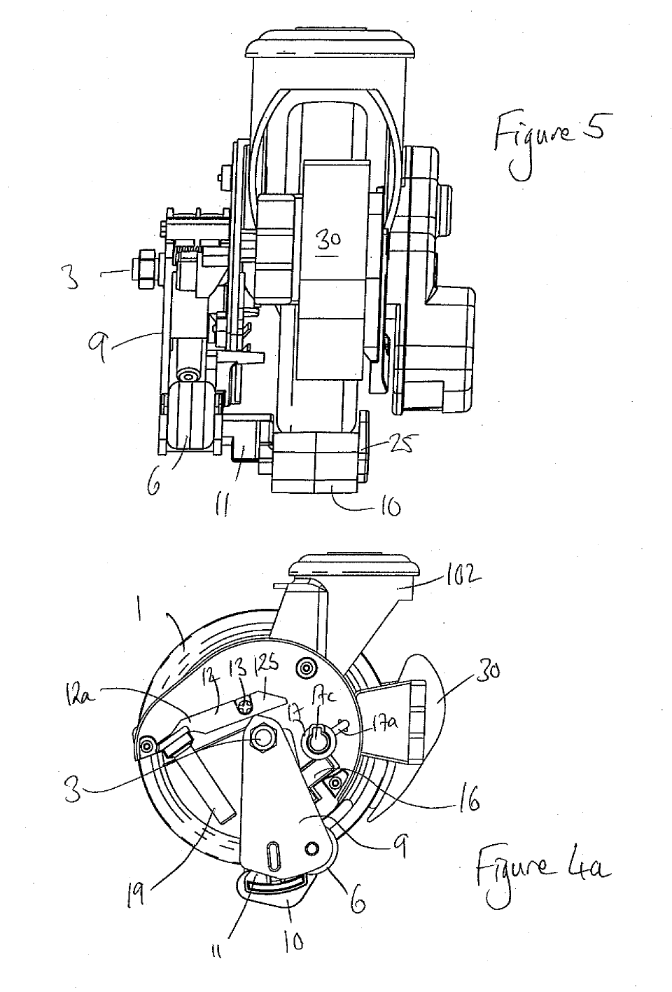

FIG. 5 is an end view of the castor of FIG. 4;

FIG. 6 is similar to FIGS. 4 and 5 and shows the braking arrangement displaced to a full braking condition;

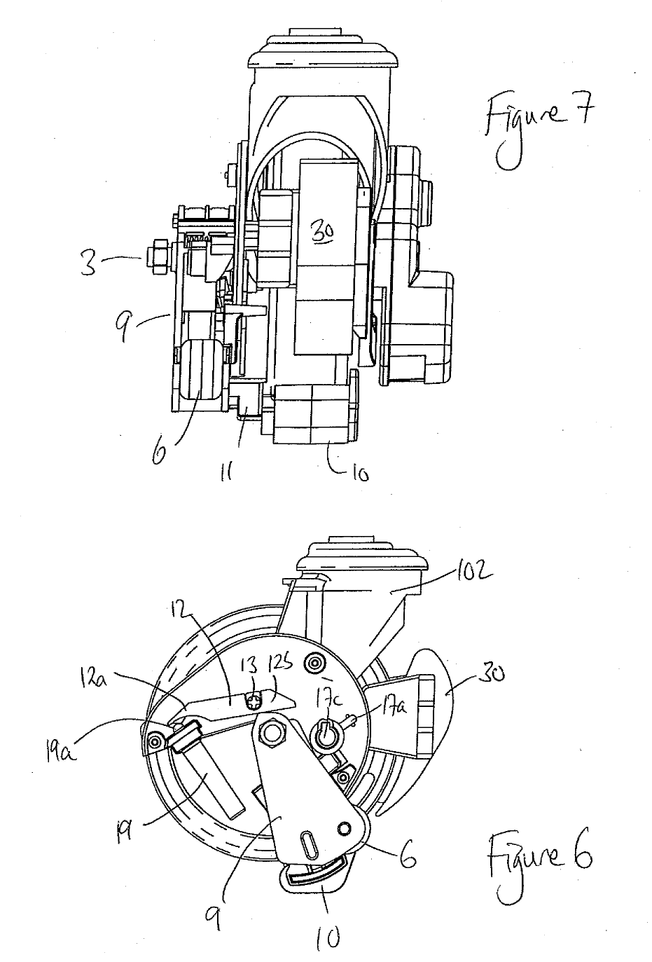

FIG. 7 is an end view of the castor of FIG. 5;

FIG. 8 is a view similar to FIG. 6 and shows the action of a release mechanism for returning the braking assembly to the free running condition;

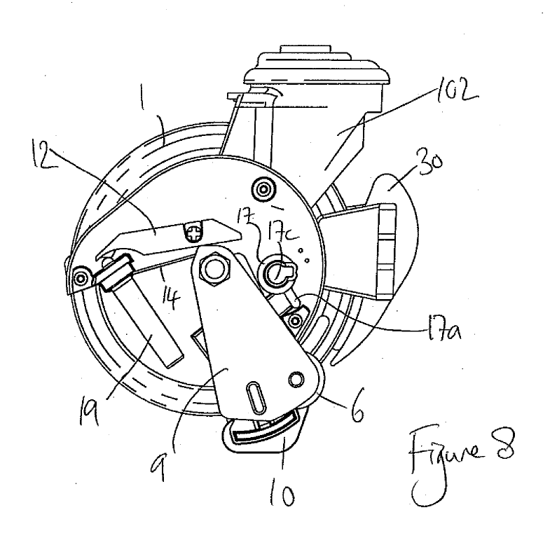

FIG. 9 is a view of one side of a base plate for mounting components of the assembly of the invention;

FIG. 10 is a view of the reverse side of the base plate of FIG. 9;

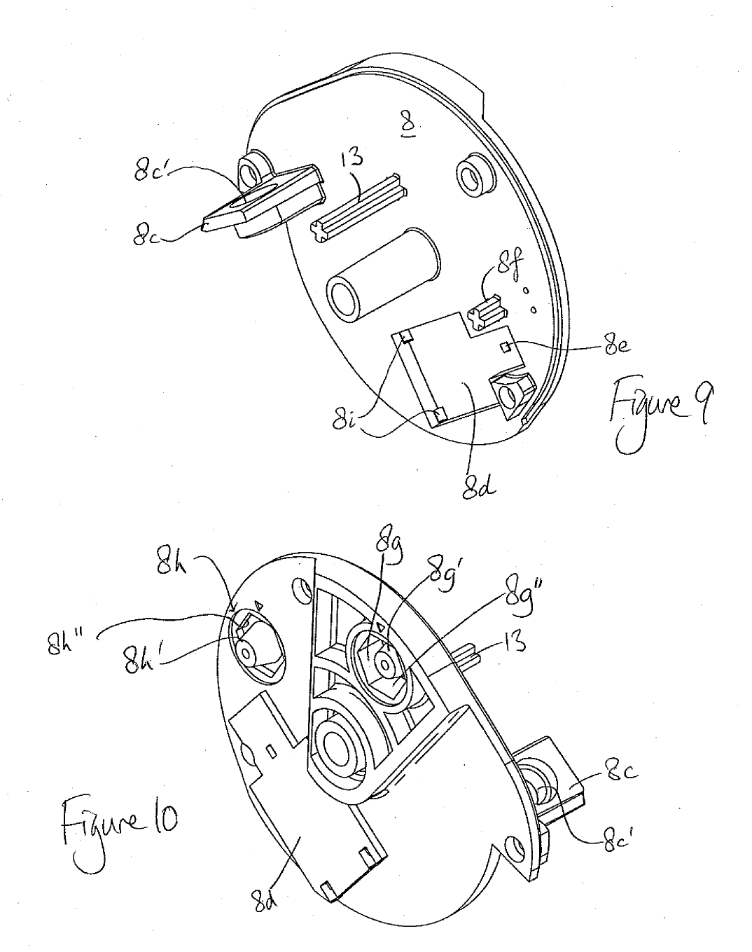

FIG. 11 is a view of a brake arm unit of the brake assembly of the invention;

FIG. 12a is a view of the other side of the brake arm unit of FIG. 11;

FIG. 12b shows a jockey wheel for mounting in the brake arm unit;

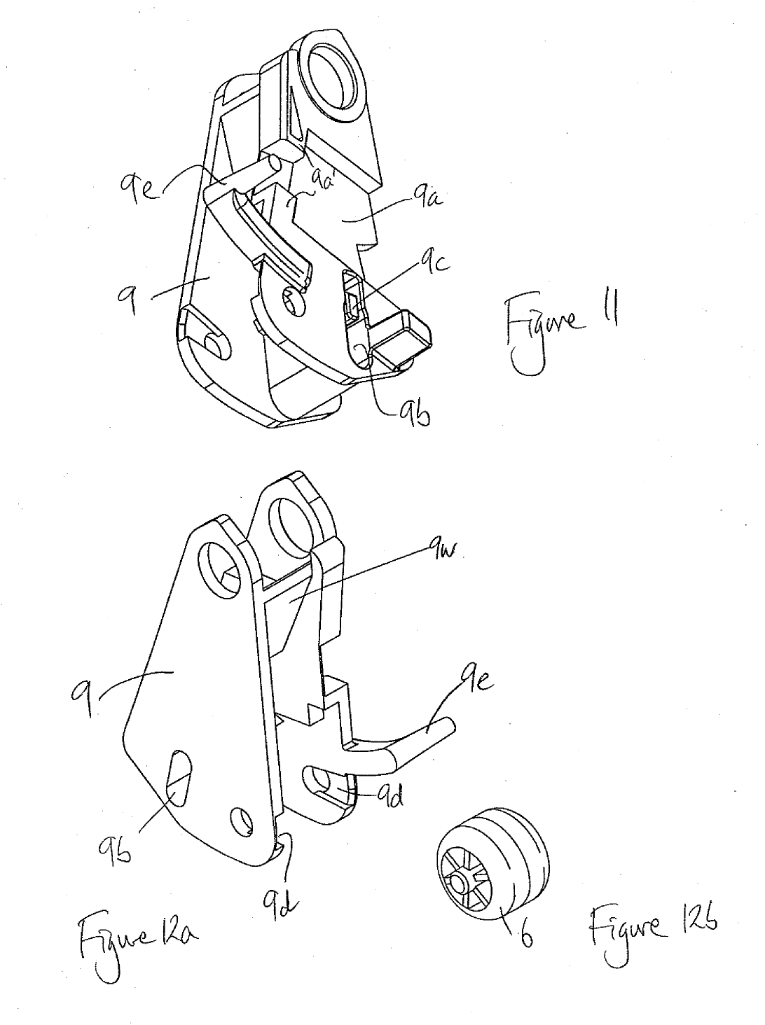

FIGS. 13a and 13b show a latching component for retaining the braking arm unit in the braking configuration;

FIGS. 14a and 14b show a cam lever for releasing the brake arm unit from the braking condition;

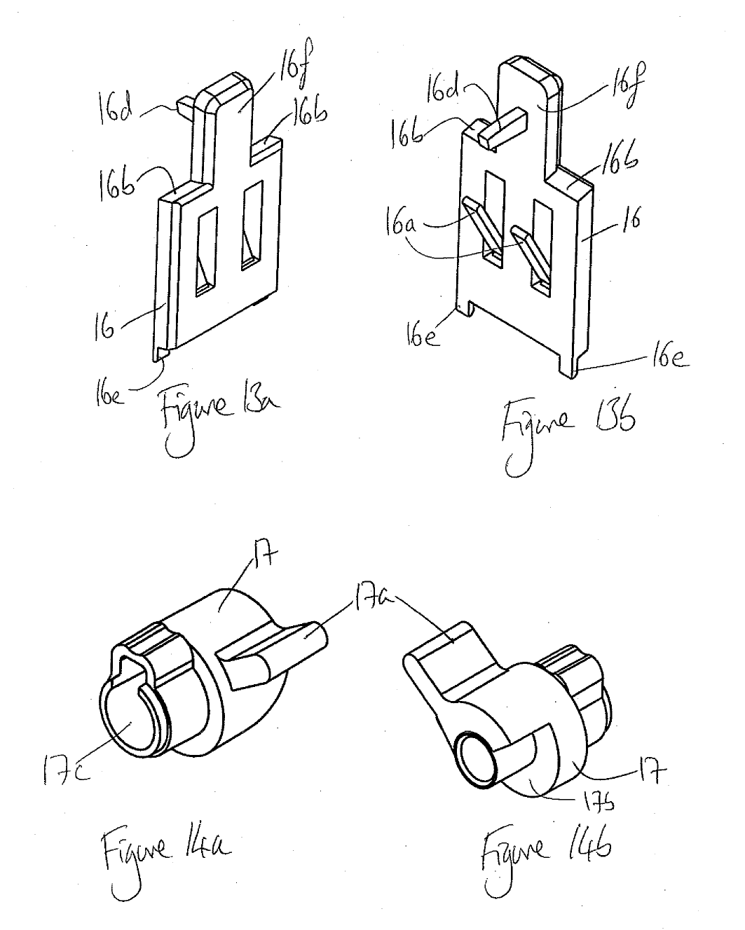

FIGS. 15a and 15b show a cover for the braking assembly of the invention;

FIGS. 16a and 16b show a damper lever;

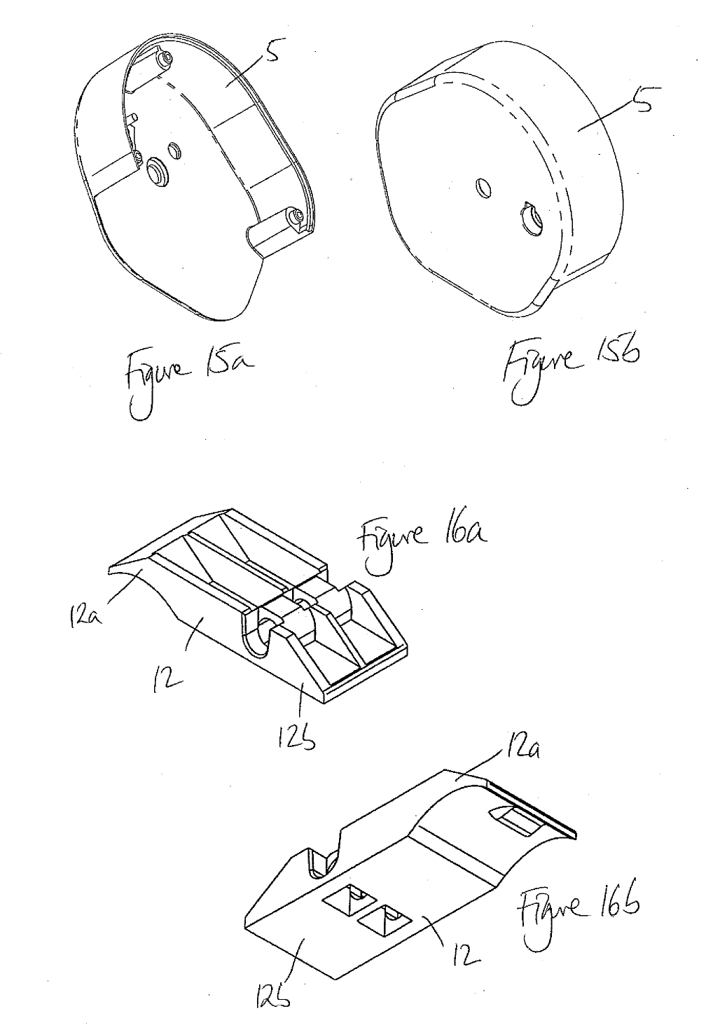

FIGS. 17a and 17b show a brake pad holder for use in the assembly of the invention;

FIGS. 18a and 18b show a primary retaining clip for retaining a brake pad on a brake pad holder;

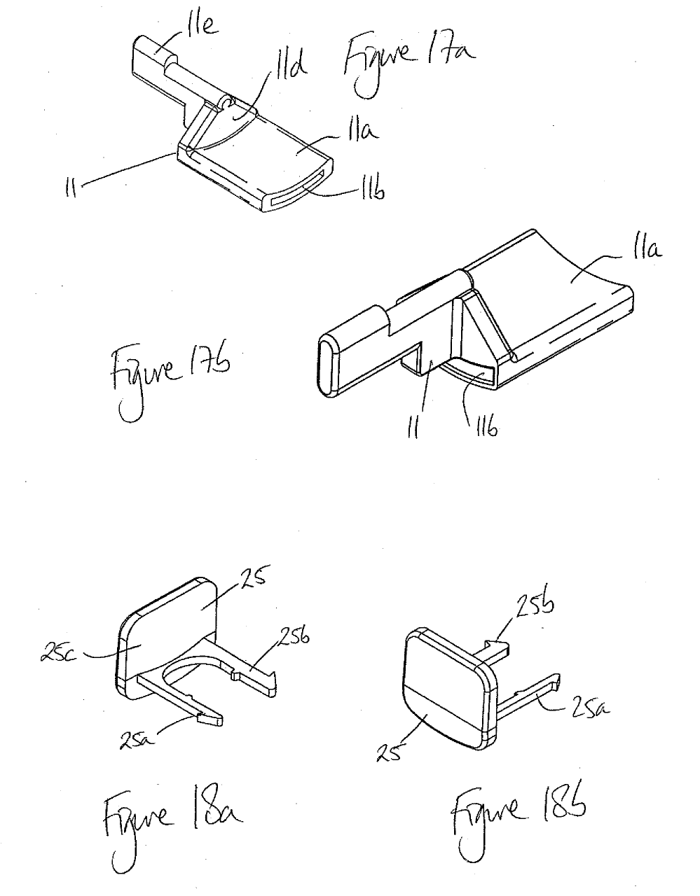

FIGS. 19a and 19b show a secondary retaining clip for retaining a brake pad on a brake pad holder;

FIGS. 20a and 20b show a brake pad for use with the braking assembly of the invention;

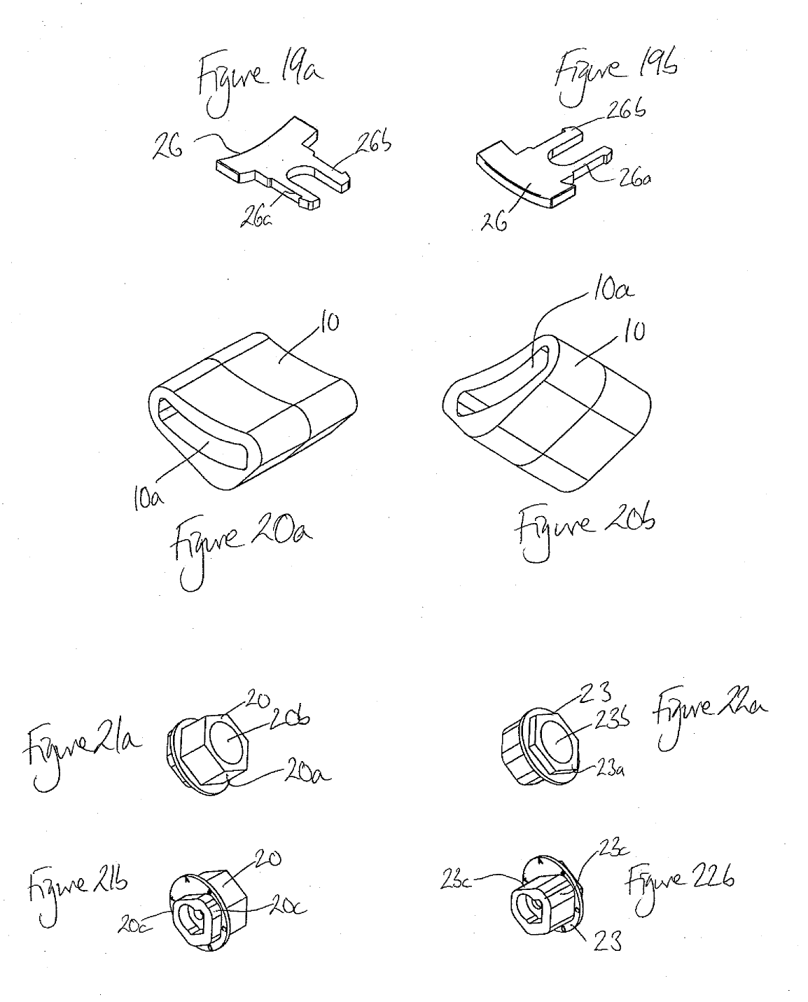

FIGS. 21a and 21b show a first castor lug for use in the assembly of the invention;

FIGS. 22a and 22b show a second castor lug for use in the assembly of the invention.

Referring now to the drawings, the braking arrangement 100 is shown mounted for co-operation with a wheel member (castor 1) of a shopping cart. The shopping cart includes a fork 102 to which the shopping cart body (not shown) is attached. The fork 102 provides a mounting for castor 1 by means of an axle bolt 3. The braking arrangement 100 is also secured on the fork 102 by means of the axle bolt 3.

The braking arrangement 100 includes a cover 5 which provides protection for components of the braking arrangement 100, prevents unauthorised access to the braking arrangement and also provides an aesthetically pleasing finish.

As can be seen in particular from FIG. 2 the braking arrangement 100 includes a brake arm 9 which is mounted at one end on axle bolt 3 and is configured to rotate about axle bolt 3. The brake arm 9 extends generally radially from axle bolt 3 and at its end distal from the axle bolt 3 carries a jockey wheel 6 and a brake pad 10. In the configuration shown in FIGS. 2 and 3 the castor 1 and jockey wheel 6 contact the ground or running surface 4 but the brake pad 10 is spaced apart from the running surface 4. Therefore, in this configuration the brake pad 10 exerts no braking action.

The brake arm 9 is subject to a biasing means which urges the brake arm to rotate about the axle bolt 3 towards a configuration in which the brake pad is brought into contact with the running surface. In FIGS. 2, 4 and 6 the biasing means urges the brake arm 9 to move in an anti-clockwise (counter-clockwise) direction. As can be seen in particular from FIG. 4b one preferred biasing means is a torsion spring 14, one arm of which acts on an internal lateral wall or other suitable formation 9w of the brake arm 9. The other arm of the torsion spring 14 engages a suitable fixed formation of a back or base plate 8. The base plate 8 is mounted on the fork 102 of the shopping cart by means of axle bolt 3.

When the castor or wheel 1 is in contact with the running surface 4 jockey wheel 6 remains in contact with the ground and the brake arm 9 is prevented from moving towards the braking configuration in which the brake pad 10 contacts the running surface 4. However, when the castor 1 is spaced from the running surface 4, such as when the shopping cart is lifted, the biasing means (torsion spring 14) urges the brake arm to rotate about the axle bolt 3. Such rotation brings the brake pad 10 into a position at which, as the castor 1 is moved back towards the running surface, the brake pad 10 contacts the running surface. This configuration of the brake arm is shown in FIG. 6 and an intermediate configuration between the free running configuration and the full braking configuration is shown in FIGS. 4a and 4b.

However, it is not desirable for the braking arm 9 to move to the braking configuration immediately the castor 1 is moved out of contact with the running surface 4. For this reason, the braking arrangement of the invention provides a damping assembly which delays the movement of the brake arm 9 towards the braking configuration. The damping assembly comprises a damper 19 which is mounted in a damper holding formation 8c of the base plate 8. Conveniently, damper receiving formation 8c also functions as the formation which retains the arm of the torsion spring 14.

In the illustrated embodiment, formation 8c includes a through bore 8c′ in which the body of the damper 19 is located. In preferred configurations the damper 19 is a hydraulic damping arrangement which comprises a cylinder containing a piston 19a. A portion of the piston 19a extends outside the cylinder. The cylinder contains a fluid such as an oil which restricts the movement of the piston within the cylinder. For example, the piston may include a head portion which is a close fit with the interior surface of the cylinder such that on movement of the piston the oil must be forced around the piston head or, for example, forced through small apertures in the piston. The damping arrangement further comprises a rocker arm or damper lever 12 which is mounted on a pivot 13. Pivot 13 is also preferably a formation depending from the base plate 8. A first end 12a of the rocker arm 12 is in contact with the exposed portion of the piston 19a. In preferred configurations, the first end 12a of the rocker arm 12 comprises a concave running surface which contacts the external end of the piston element 19a. An opposed second end 12b of the rocker arm 12 contacts the brake arm 9. The end of the brake arm 9 distal from the brake pad 10 is shaped to provide a camming surface, the camming surface being in contact with the second end 12b of the rocker arm 12. Thus, on movement of the brake arm 9 from the free running position to the braking position, the camming surface urges the second end 12b of the rocker arm 12 to move upwardly. The rocker arm 12 pivots about formation 13 so that the first end 12a moves downwardly. Thus the first end 12a of the rocker arm 12 acts on the end of the piston 19a and urges the piston to move into the cylinder. In this way, the damper resists movement of the brake arm 9 towards the braking position. It is recalled that the brake arm 9 is biased by the biasing means 14 towards the braking position. The bias of the biasing means 14 is greater than the resistance offered by the damper 19 so that ultimately when the castor 1 is lifted away from the running surface 4 the piston 19a is urged into the damper body 19 and the brake arm 9 moves to the braking configuration.

Locking means are provided to automatically retain the brake arm 9 in the braking configuration. In the preferred embodiment as illustrated, the locking means are a latching arrangement. The latching arrangement comprises a plate or the like 16 which includes one or more resilient tongues 16a. The plate 16 is mounted on the base plate 8, for example, in a correspondingly shaped recess 8d. The resilient tongues 16a are configured to extend in their resting position out of the plane of the plate 16. Preferably, the plate 16 also includes one or more locating means such as projections 16d and 16e which assist in retaining the plate 16 on the base plate 8. Thus, the projection 16d is accommodated in a hole 8e of the base plate 8 and projections 16e are accommodated in holes or formations 8i of the base plate 8. The plate 16 is mounted on the base plate 8 such that the projecting tongues 16a are directed towards the interior of the recess 8d. Thus, the projecting tongues 16a hold at least the end portion 16f of the plate 16 so that it lies above the plane of the base plate 8. When the brake arm 9 moves towards the braking configuration, the brake arm 9 passes over the plate 16 and urges it into the recess 8d so that the tongues 16a are resiliently deformed towards the plane of the plate 16. The brake arm 9 defines a recess 9a which is sized to accommodate the plate 16 in its non-resiliently deformed condition. The brake arm 9 also includes suitably configured walls or abutments 9a′ which engage corresponding shoulders 16b of the plate 16 when the plate is in its rest condition (that is when the plate is not resiliently deformed) thereby preventing the brake arm 9 from moving towards the free running condition. Thus, the brake arm 9 remains in the braking configuration and the shopping cart is made very difficult to move.

It is, of course, desirable to provide a release mechanism which permits the brake arm 9 to be returned from the braking configuration to the free running configuration. To this end, a reset cam lever 17 is mounted on the base plate 8. Conveniently the base plate 8 includes a post 8f on which the reset cam lever 17 is mounted. The reset cam lever 17 includes a camming surface 17b and a key slot 17c. In use, the reset cam lever 17 is covered by cover 5 so that only the key slot 17c is accessible. The reset cam lever 17 is positioned on the base plate so that the camming surface 17b is disposed above end part 16f of the latching plate 16. The recess cam lever 17 is rotatable by an authorised user who is in possession of a key configured to enter slot 17c. Rotation of the reset cam lever 17 by means of the key causes the camming surface 17b to engage the end 16f of the latching plate 16 and to depress the plate 16 towards base plate 8. The shoulders 16b of the plate 16 then become disengaged from the latching walls 9a′ of the brake arm 9 and the brake arm 9 is then free to return to the free running configuration, but subject to the action of damper 19. In preferred arrangements, the camming surface of the brake arm 9 at its end distal from the brake pad 10 is configured such that movement of the brake arm 9 from its braking position towards its free-running position requires at least some deflection of the rocker arm 12 about the pivot 13 to cause at least some depression of the piston 19a into damper cylinder 19. Of course, even when the reset cam lever 17 has been rotated to depress the plate 16, the brake arm 9 can move towards the free running condition only when the brake pad 10 is not in contact with the running surface 4, or by movement of the shopping cart as a whole with the brake pad 10 remaining initially in contact with the ground.

To assist in returning the brake arm 9 towards the free running condition, the reset cam lever 17 is also provided with a generally radially projecting arm 17a. The arm 17a is positioned on the reset cam lever 17 such that during rotation of the reset cam lever 17 to depress the plate 16 the arm 17a engages a side surface of the brake arm 9 and urges the brake arm towards the free running condition, initially at least against the action of the damper 19.

Brake pad 10 is mounted on a brake pad holder 11. As can be seen in particular from FIGS. 20a and 20b brake pad 10 includes an internal void or passage 10a which receives a mounting portion 11a of the brake pad holder 11. Primary and secondary retaining clips are used to retain the brake pad 10 on the mounting portion 11a. Primary retaining clip 25 includes arms 25a and 25b each with projecting latching formations. The arms 25a and 25b are accommodated in the slot 11b of mounting portion 11a. Secondary retaining clip 26 includes legs 26a and 26b which are also inserted into slot 11b, from the other end with respect to clip 25, and assist in retaining clip 25 in position. Clip 25 further includes a rim 25c which prevents the brake from being distorted and forced in use too far towards the assembly of the invention. Rim 25c will come alongside the wheel 1 when the braking arm 9 is in the braking configuration and thus act to block further inward movement. Brake holder 11 is mounted in brake arm 9 by means of shoulder 11d and raised ridge 11e.

Brake arm 9 includes a through hole 9b in which portion 11e of the brake holder 11 is located. Through hole 9b also includes a sprung arm 9c which biases the brake pad 10 away from the castor when the brake arm 9 is in the free running position. When the brake arm 9 is in the braking position the sprung arm 9c flexes when the brake pad 10 comes between the wheel 1 and the running surface 4.

FIGS. 2, 4A, 4B, 6 and 8 all show a further braking arrangement 30 which will not be described in detail. This braking arrangement 30 is of the sort which is activated by an RF signal or magnetic field as described above. It would, however, be undesirable for the brake arm 9 to move from the free running configuration to the braking configuration after the brake 30 has been activated. For this reason, the brake arm 9 includes a projecting formation 9e which can interact with the alternative braking system 30 to prevent movement of the brake arm 9 into the braking configuration after the alternative braking system 30 has been activated.

Referring now in particular to FIGS. 9, 10, 21A, 21B, 22A and 22B it will be readily appreciated that different manufacturers of shopping carts produce forks 102 which are of different shapes. For this reason, the base plate 8 is provided with means which enable it to be mounted on forks 102 or various shapes. In the preferred example as illustrated, the base plate 8 is provided with two location points 8g, 8h for lugs 20 and 23. One side of lug 20 is provided with a projection 20a which has a hexagonal external shape in cross section and an internal bore 20b. The bore receives a frusto-conical projection 8g′ of the base plate 8 and the hexagonal projection is received in a correspondingly shaped recess 8g″. Thus, the lug 20 can be accommodated at 8g in any one of six positions. The other side of the lug 20 as shown in FIG. 21b includes a plurality of camming faces 20c which are configured to engage, for example, edge portions of the forks 102. A different camming face is presented in each one of the six possible positions of the lug 20. Lug 23 which is shown in FIGS. 22a and 22b is similarly constructed but with different relative proportions.

1. Apparatus for preventing rotation of at least one wheel member, comprising:
at least one braking member rotatable about an axis of a wheel member between a non-braking position and a braking position;
at least one biasing element arranged to bias the braking member to rotate into the braking position; and
a damping assembly arranged to selectively resist a bias provided by the biasing element.

2. The apparatus as claimed in claim 1 wherein the damping assembly further comprises:
a hydraulic unit comprising a piston element, cylinder element in which the piston element at least partially extends and damping fluid arranged to selectively resist motion of the piston element in the cylinder element; and
a rocker arm having a first end arranged to press against an external end of the piston element and a further end arranged to press against a contact surface of the braking member.

3. The apparatus as claimed in claim 2 wherein the first end of the rocker arm comprises a concave running surface on which the external end of the piston element is urged.

4. The apparatus as claimed in claim 1 wherein the damping assembly selectively resists the biasing effect for a predetermined period of time subsequent to the wheel/member being removed from a running surface.

5. The apparatus as claimed in claim 2 wherein the braking member further comprises:
an elongate brake arm member arranged to pivot about the axis of the wheel member at a first end region and including a cam surface providing the contact surface on which the external end of a rocker arm rides.

6. The apparatus as claimed in claim 5, further comprising:
a jockey wheel rotatable about a minor axle at a distal end region of the brake arm.

7. The apparatus as claimed in claim 5, further comprising:
a locking plate; and
at least one locking plate biasing member arranged to urge a free end of the locking plate away from a base plate member; wherein
the brake arm member urges the locking plate against the base plate member as the brake arm member moves from a non-braking position to the braking position.

8. The apparatus as claimed in claim 7, wherein:
the free end of the locking plate is arranged to spring away from the base plate member when the brake arm member is located in the braking position to thereby prevent counter rotation of the brake arm member to lock the brake arm member in the braking position.

9. The apparatus as claimed in claim 7 further comprising a release assembly, the release assembly comprising:
a rotatable body portion comprising a keyhole region and cam portion, the keyhole region being arranged to receive a reset key, the body portion being rotatable with turning of the reset key to thereby engage the cam portion with the locking plate to urge the locking plate against the base plate member.

10. The apparatus as claimed in claim 7, further comprising:
a recess in the base plate member to receive the locking plate.

11. The apparatus as claimed in claim 5, further comprising:
a locking arm extending from the brake arm member to engage with an adjacent braking system and selectively prevent the braking member being located in the braking position when the adjacent braking system is deployed.

12. The apparatus as claimed in claim 7, wherein:
the base plate member comprises at least one base recess comprising a central pin element and at least one angled side wall region; and
wherein the apparatus further comprises a locking nut element, for each base recess, having a first side comprising a nut recess and angled side wall locatable in the base recess, and a further side comprises a contact surface offset from a central axis of the nut element.

13. The apparatus as claimed in claim 12, wherein:
the base plate member comprises two recesses.

14. A castor for a shopping cart, comprising:
a wheel member;
a horn member comprising forks between which the wheel member is arranged to rotate about the wheel axis; and
the apparatus as claimed in claim 1.

15. The castor as claimed in claim 14, further comprising:
a braking assembly arranged to retard motion of the wheel member responsive to a wireless trigger.

16. A shopping cart comprising the castor as claimed in claim 14.

17. A method of preventing rotation of at least one wheel member of a castor, comprising the steps of:
during a non-braking mode of operation in which a wheel member of the castor runs in contact with a running surface, maintaining at least one braking member in a non-braking position;
during a braking mode of operation in which the wheel member of the castor is removed from contact with the running surface, urging the braking member into a braking position in which the braking member is located between the wheel member and the running surface; and
immediately subsequent to the removal of the wheel member from contact with the running surface, via a damping assembly, selectively resisting a biasing effect of at least one biasing member arranged to bias the braking member into the braking position.

18. The method as claimed in claim 17, further comprising the steps of:
resisting biasing of the braking member into the braking position for a predetermined period of time immediately subsequent to removal of the wheel member of the castor from the running surface.

19. The method as claimed in claim 17, further comprising the steps of:
subsequent to biasing of the braking member into the braking position, locking the braking member in the braking position via a locking plate.

20. The method as claimed in claim 19, further comprising the steps of:
subsequent to locking the braking member in the braking position, releasing the braking member by turning a key in a keyhole of a release assembly thereby turning a cam portion of a rotatable body, rotation of the cam portion urging the locking plate into a recess on a base plate member to thereby release the braking member.

21. The method as claimed in claim 17, further comprising securing a base plate to a fork of the castor by the steps of:
selectively locating a first nut element in a base recess and holding the fork between an abutment surface and a contact surface of the nut.

22. The method as claimed in claim 21, further comprising the steps of:
the abutment surface comprises a contact surface of a further nut element.

23. The method as claimed in claim 21, further comprising the steps of:
prior to holding the base plate, selectively orientating at least one nut element in one of a plurality of possible orientations in a respective recess of the base plate.

24. The method as claimed in claim 17, further comprising the steps of:
preventing movement of the braking member into the braking position if a braking assembly of the castor is deployed.

25.-26. (canceled)
